(19) United States
(12) Patent Application Publication
(10) Pub. No.: US 2026/0326674 A1
(43) Pub. Date: Oct. 22, 2026

(54) Vehicle with a Vehicle Body and with Roof Rails Connected Thereto

(71) Applicant: Bayerische Motoren Werke Aktiengesellschaft, Muenchen (DE)

(72) Inventors: Christian MUELLER, Tutzing (DE); Richard ZAUSINGER, Siegenburg (DE)

(21) Appl. No.: 19/651,175

(22) Filed: Apr. 17, 2026

(30) Foreign Application Priority Data
Apr. 22, 2025 (DE) 10 2025 115 384.1

(51) Int. Cl. B60R 9/04; B60R 13/04; B60R 13/06

(52) U.S. Cl. CPC B60R 9/04; B60R 13/04; B60R 13/06

(57) ABSTRACT

A vehicle is described with a vehicle body and roof rails which are connected thereto and each extend in the vehicle longitudinal direction in the region of outer sides of the vehicle roof. A lateral outer wall region of each of the roof rails and an upper side, associated with one of the outer wall regions, of the vehicle body, are each covered by a faceplate. A first lateral region of each of the faceplates is connected to one of the roof rails. A second lateral region of each of the faceplates defines a gap with a region of the upper side of the vehicle body, the gaps each being sealed by a sealing unit.

### CROSS REFERENCE TO RELATED APPLICATION

This application claims priority under 35 U.S.C. §119 from German Patent Application No. 10 2025 115 384.1, filed Apr. 22, 2025, the entire disclosure of which is herein expressly incorporated by reference.

### BACKGROUND AND SUMMARY

The invention relates to a vehicle with a vehicle body and with roof rails connected thereto which extend in a vehicle longitudinal direction in outer side regions of the vehicle roof.

A roof rail for a motor vehicle having at least one rail bar and at least one supporting element that is fastened to the rail bar in order to bridge a distance formed between the rail bar and the roof of the motor vehicle and to attach the roof rail to the roof of the motor vehicle is known from DE 10 2012 000 827 A1. In addition, at least one cover for the supporting element is provided. The rail bar, the supporting element and the cover are formed as separate components. The cover has at least one fastening region, which is held in a gap formed between the rail bar and the supporting element in order to fasten the cover.

Fastening the roof rail to the roof via the rail bar, however, is problematic. This region is subject to aesthetic and visual requirements, which limits the freedom when designing the component strength of the vehicle roof.

The object of the present invention is therefore to provide a vehicle with a vehicle body and with roof rails connected thereto, in which a component strength of the vehicle body in the region in which it is connected to the roof rails can be implemented, or rather can be carried out, with a high degree of freedom and which makes a pleasing overall visual impression.

According to the invention, this object is achieved with a vehicle having the features of the independent claim(s).

The vehicle according to the invention comprises a vehicle body and roof rails connected thereto, the roof rails each extending in the vehicle longitudinal direction in the region of outer sides of the vehicle roof.

According to the invention, a lateral outer wall region of each of the roof rails and an upper side, associated with one of the outer wall regions, of the vehicle body are each covered by a faceplate. A first lateral region of each of the faceplates is connected to one of the roof rails, while a second lateral region of each of the faceplates defines a gap with a region of the upper side of the vehicle body. The gaps are each sealed against the surroundings of the vehicle by means of a sealing unit.

The arrangement of the faceplates on the outer side of the vehicle with respect to the outer wall regions of the roof rail and above the upper sides of the vehicle body enables the vehicle body and the roof rail to be designed so as to be optimally load-bearing without having to take into account aesthetic or visual requirements.

In an advantageous development of the vehicle according to the invention, the first lateral regions of the faceplates each engage in a groove of the roof rails. This allows, on the one hand, a good appearance of the seam to be provided at the transition between the faceplates and the vehicle body. On the other hand, it is easily possible to seal the regions of the roof rails and the vehicle body covered by the faceplates against the surroundings of the vehicle.

The grooves can each have a substantially C-profiled cross section, and ends, running so as to be directed towards each other, of groove legs can each define an opening cross section and rest flush against lateral surfaces of the faceplates. This allows the faceplates to be connected easily to the roof rails in a form-fitting, force-fitting and/or materially bonded manner and the connection to be implemented such that no noises that could disrupt the comfort of the ride occur in the connecting region between the faceplates and the roof rails while the vehicle is being driven.

Furthermore, the connection of the faceplates to the roof rails is a type of swivel joint between the roof rails and the faceplates and enables the faceplates to tilt relative to the roof rails. Tilting of the faceplates relative to the roof rails makes it possible to compensate for misalignments of the roof rails relative to the surfaces of the vehicle body resulting from manufacturing tolerances. This allows a uniform and visually appealing seam to be provided in the region of the gaps between the faceplates and the upper sides of the vehicle body.

To this end, it is advantageous if the opening cross sections of the grooves are smaller than a groove cross section adjoining the opening cross section in the direction of a groove base. Then, an end of each of the faceplates engaging in each of the grooves can tilt relative to the roof rails without coming into contact with the inner sides of the groove and possibly generating misalignments between the faceplates and the roof rails in the region of the grooves.

In a connecting region which is associated with the roof rails and lies between the lateral regions, the faceplates can each be in operative connection with the roof rails via at least one resilient coupling element. Such a resilient coupling element makes it possible in a structurally simple manner to, on the one hand, establish a connection between the faceplates and the roof rails and, on the other hand, avoid misalignments of the faceplates that would impair the appearance of the seam due to the component elasticities of the coupling elements.

In a structurally simple development of the vehicle according to the invention, the coupling elements each comprise at least one flat spring, preferably a leaf spring, which are connected at one end to the faceplates and at the other end to the roof rails and each apply a positioning force directed in the direction of the upper sides of the roof rails to the faceplates. As a result, the faceplates are each held by the flat springs in a position that provides a visually appealing seam in the region of the gaps between the second lateral regions of the faceplates and the upper sides of the vehicle body, regardless of the position of the roof rails.

Alternatively or additionally, it is also possible for the coupling elements to each have at least one so-called spring clip, which are each firmly connected to the faceplates and each engage in a further groove of the roof rails when the faceplates are mounted and can be displaced in the further grooves against a spring pretensioning of the spring clips and at the same time are held such that they are prevented from escaping from the further grooves. In this case, it is also possible for the spring pretensioning of the spring clips to apply a positioning force directed in the direction of the upper sides of the roof rails to each of the faceplates.

The further grooves can each be formed in a region of a support arm of the roof rails, with which the roof rails engage under the faceplates starting from the first lateral region in the direction of the second lateral region. Due to the support arms, it is in turn possible with little effort to connect the faceplates between the lateral regions, again in a resilient manner, to the roof rails in order to achieve a visually good seam appearance in the region of the gaps.

In the region of an underside, the roof rails can each rest on a bearing surface of the vehicle body and can be firmly connected to the vehicle body. It is then possible to support, to the desired degree, forces that are exerted on the roof rails and are introduced for example by roof boxes that are fastened to the roof rails via roof racks, in the region of the vehicle body.

Furthermore, it can be provided that the sealing units are arranged between undersides of the second lateral regions of the faceplates, which face the upper sides of the vehicle body, and the upper sides of the vehicle body in order to seal the gaps between the faceplates and the vehicle body. In addition, the sealing units can apply a positioning force directed away from the upper sides of the vehicle body to each of the faceplates.

In combination with the connections of the faceplates to the roof rails, via the resilient coupling elements in the region of the further grooves and via the first lateral regions in the region of the grooves, the component elasticities of the sealing units enable a uniform appearance of the seam to be presented within a tolerance range of a series of a vehicle type. This is independent of tolerance-dependent positions of the roof rails with respect to the surfaces of the vehicle body, which define the gaps together with the second lateral regions of the faceplates.

The faceplates can each have a stop region in the region of their lateral surfaces that face the support arms of the roof rails. To define a swiveling angle of the faceplates about the first lateral regions of the faceplates in the direction of the support arms, free ends of the stop regions can come to rest on the support arms. As a result, a swiveling angle range of the faceplates relative to the roof rails can be defined in a structurally simple manner.

In the vertical direction above the grooves, the roof rails can each have a cross-sectional region that is constricted in the transverse direction and a cross-sectional region that adjoins the former region in the vertical direction and is wider in the transverse direction. Then, crossbars, or rather roof racks, can be easily fastened to the roof rails – crossbars which extend above the vehicle roof in the vehicle transverse direction and engage under the wider cross-sectional region, for example with clamps or the like.

It can also be provided that the roof rails have, at least in the constricted cross-sectional region, a hollow profile which comprises a web region that runs in the transverse direction, extends between lateral walls and defines the hollow profile. Then the roof rails are implemented with a desired high strength in the region where the crossbars, or rather roof racks, are mounted while also being lightweight.

Further features of the invention emerge from the claims, the figures and the description of the figures. The description above of the features and combinations of features, and the features and combinations of features mentioned below in the description of the figures and/or shown in the figures alone can be used not only in the respectively specified combinations but also in other combinations or on their own.

### BRIEF DESCRIPTION OF THE DRAWINGS

FIG. 1 is a three-dimensional side view of a roof rail of a vehicle;

FIG. 2 is an enlarged view of a region II, labeled specifically in FIG. 1, of the roof rail;

FIG. 3 is a sectional view of the roof rail, a region of a vehicle body arranged below it and a faceplate along a sectional line III-III labeled in FIG. 2;

FIG. 4 is a sectional view of the roof rail, the region of the vehicle body arranged below it and the faceplate along a sectional line IV-IV labeled in FIG. 2;

FIG. 5 is a three-dimensional partial cross-sectional view of a region of a further embodiment of the roof rail, in which the faceplate is in operative connection with a support arm of the roof rail via a flexible coupling element formed as a spring clip in order to compensate for tolerances; and

FIG. 6 is, substantially corresponding to FIG. 5, a cross-sectional view of the roof rail, the vehicle body and the faceplate, wherein the faceplate is in operative connection with the support arm of the roof rail via a flat spring and the spring clip.

### DETAILED DESCRIPTION OF THE DRAWINGS

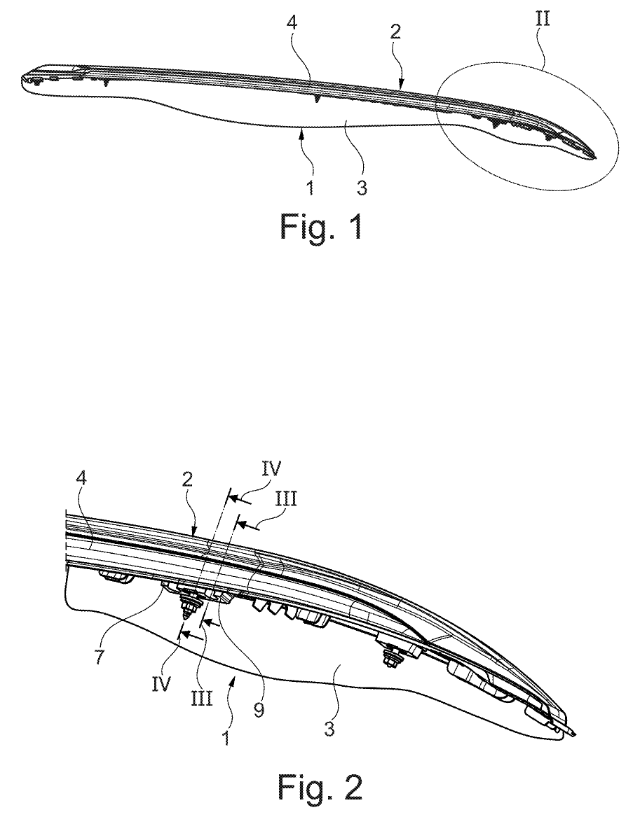

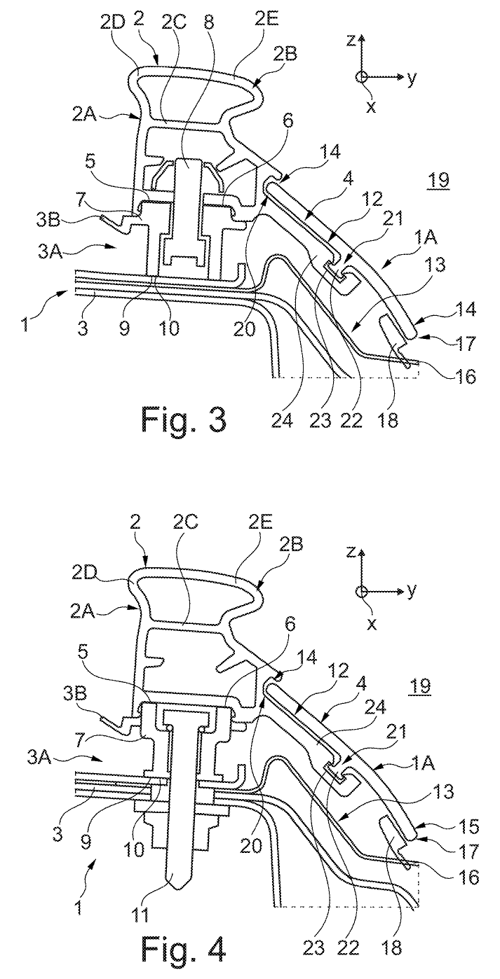

FIG. 1 shows a three-dimensional partial representation of a vehicle 1 and a roof rail 2 which is connected to a vehicle body 3. FIG. 2 shows an enlarged view of a region II, labeled specifically in FIG. 1, of the roof rail 2, the region comprising an end of the roof rail 2. FIGS. 3 and 4 each show sectional views of the roof rail 2, the vehicle body 3 and a faceplate 4 along sectional lines III-III and IV-IV, respectively, labeled specifically in FIG. 2.

From the representation according to FIG. 3, it can be seen that an underside 5 of the roof rail 2 rests on a bearing surface 6 of an adapter element 7, which is firmly connected to the roof rail 2 of the vehicle body 3 via a screw joint 8 and engages at least in regions in a roof channel 3A in the vehicle vertical direction Z. A roof channel sealing unit 3B is provided between the roof rail 2 and regions of the vehicle body 3 defining the roof channel 3A.

An underside 9 of the adapter element 7 rests on a bearing surface 10 of the vehicle body 3 and is firmly connected to the vehicle body 3 via a further screw joint 11. The roof rail 2 also extends, in the region of an outer side 1A of the vehicle roof, over nearly the entire length of the roof in the vehicle longitudinal direction X and is firmly connected to the vehicle body 3 in the present example via three adapter elements 7.

A lateral outer wall region 12 of the roof rail 2 and an upper side 13 of the vehicle body 3, the upper side facing, or rather associated with, the outer wall region 12, are covered by the faceplate 4, which extends over nearly the entire length of the roof rail 2. A first lateral region 14 of the faceplate 4 is connected to the roof rail 2 and a second lateral region 15 of the faceplate 4 defines a gap 17 with a region 16 of the upper side 13 of the vehicle body 3. The gap 17 is sealed against the surroundings 19 of the vehicle 1 by means of a sealing unit 18. For this purpose, the sealing unit 18 is arranged between the second lateral region 15 of the faceplate 4 and the upper side 13 of the vehicle body 3 in order to seal the gap 17 between the faceplate 4 and the vehicle body 3. The sealing unit 18 thereby applies a positioning force directed away from the upper side 8 of the vehicle body 3 to the faceplate 4.

In the present example, the free end of the first lateral region 14 of the faceplate 4 engages in a groove 20 of the roof rail 2. The groove 20 has substantially a C-profiled cross section. The faceplate 4 forms an acute angle with the vehicle vertical direction Z, wherein, when the faceplate 4 is in the installed position, the first lateral region 14 is arranged above the second lateral region 15 in the vehicle vertical direction Z. In addition, the second lateral region 15 of the faceplate 4 lies farther to the outside in the vehicle transverse direction Y than the first lateral region 14 of the faceplate 4.

Additionally, in a connecting region 21 which is associated with the roof rail 2 and lies between the lateral regions 14 and 15, a clip-like connecting element 22 of the faceplate 4 engages in a further groove 23 of a support arm 24 of the roof rail 2. The support arm 24 engages under the faceplate 4 starting from the first lateral region 14 in the direction of the second lateral region 15. Depending on the particular use case, the connecting element 22 extends over the entire length of the faceplate 4 or comprises multiple connecting element portions spaced apart from each other in the vehicle longitudinal direction X.

Regardless of the specific embodiment of the connecting element 22, the connecting element 22 establishes a fixed connection between the support arm 24 and the faceplate 4 after being mounted in the further groove 23. In the mounted state, the faceplate 4 covers the region of the roof rail 2 and of the vehicle body 3 lying under it relative to the surroundings 19 of the vehicle 1 and presses the sealing unit 18 against the upper side 8 of the vehicle body 3 in order to form a seal.

Furthermore, above the groove 20 in the vehicle vertical direction Z, the roof rail 2 is formed with a cross-sectional region 2A that is constricted in the vehicle transverse direction Y and with a cross-sectional region 2B that adjoins the former region in the vehicle vertical direction Z and is wider in the vehicle transverse direction Y. The constricted cross-sectional region 2A and the wider cross-sectional region 2B make it easily possible to fasten roof racks running in the vehicle transverse direction Y to the roof rail 2, for example with clamps.

The roof rail 2 is formed as an extrusion molded profile which preferably consists of die-cast aluminum or the like. The roof rail 2 is implemented with a hollow profile in, among other regions, the constricted cross-sectional region 2A and the wider cross-sectional region 2B, the hollow profile comprising a web region 2C which runs in the vehicle transverse direction Y and extends between lateral walls 2D, 2E of the hollow profile.

In the region of the gap 17, there is a good appearance of the seam when the roof rail 2 has a predefined mounted position in the mounted state. Unfavorable component tolerance positions in the regions in which the roof rail 2 is connected to the vehicle body 3 cause the actual position of the roof rail 2 to deviate from the predefined mounted position such that the width of the gap 17 and thus the appearance of the seam between the faceplate 4 and the vehicle body 3 is influenced in an unacceptable manner.

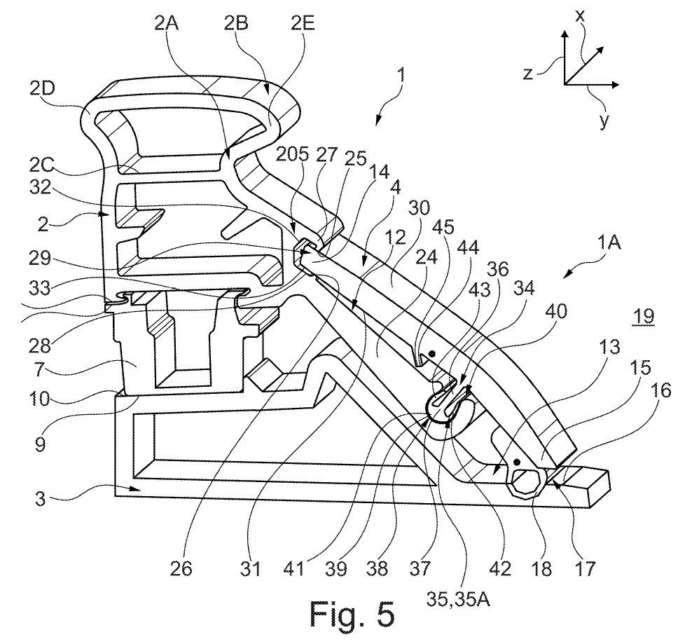

FIG. 5 shows a development of the vehicle 1 according to FIG. 1, in which the connection of the faceplate 4 to the roof rail 2 enables a swiveling movement (described in more detail below) of the faceplate 4 relative to the roof rail 2 about the first lateral region 9 of the faceplate 4. As a result, component tolerances and resulting misalignments of the faceplate 4 relative to the vehicle body 3 can be compensated for and, regardless of the component tolerances, a visually appealing seam is achieved in the region of the gap 17.

In the vehicle 1 according to FIG. 5, the free end of the first lateral region 9 of the faceplate 4 engages in a groove 205 of the roof rail 2. The groove 205 has substantially a C-profiled cross section. Furthermore, ends 25, 26, running so as to be directed towards each other, of groove legs 27, 28 define an opening cross section 29 of the groove 205 and rest flush against lateral surfaces 30, 31 of the faceplate 4.

The opening cross section 29 of the groove 205 is smaller than a groove cross section 33 which adjoins the opening cross section 29 in the direction of a groove base 32 of the groove 205 and into which the free end of the first lateral region 14 of the faceplate 4 protrudes. As a result, inner sides of the groove legs 27 and 28 are spaced apart from the lateral surfaces 30, 31 of the faceplate 4, which enables the faceplate 4 to swivel, or rather tilt, between the two ends 25, 26 of the groove legs 27, 28.

Additionally, in a connecting region 34 which is assigned to the roof rail 2 and lies between the lateral regions 9 and 10, the faceplate 4 is in operative connection with the support arm 24 of the roof rail 2 via a spring clip 35A of a resilient coupling element 35. Depending on the particular use case, the coupling element 35 extends over the entire length of the faceplate 4 or comprises multiple coupling element portions spaced apart from each other in the vehicle longitudinal direction X.

The resilient coupling element 35 comprises a web 36 which extends substantially perpendicularly away from the underside 31 of the faceplate 4, the underside facing the support arm 24, in the direction of the support arm 24 and transitions into a coupling region 37 at the end. The cross section of the coupling region 37 is larger than the cross section of the web 36 and its round outer side forms a free head end of the coupling element 35, with which the coupling element 35 engages in a further groove 38 of the roof rail 2.

The further groove 38 has substantially a tapering U-shaped cross-sectional profile, which narrows above a groove base 39 in the direction of an opening cross section 40 of the further groove 38. Extending from a tip 41 of the coupling region 37 are lateral spring arm portions 42, 43, which, when the coupling element 35 is clipped in, are pressed in a pretensioned manner against the inner sides of the further groove 38 due to a spring pretensioning intrinsic to the component in the further groove 38. Due to the embodiment of the further groove 38 and the spring clip 35A, the operative connection between the spring clip 35A and the further groove 38 of the support arm 24 causes a force acting, or rather directed, in the direction of the upper side 13 of the vehicle body 3 to be applied to the faceplate 4, the force swiveling the faceplate 4, or rather the second lateral region 15 of the faceplate 4, about the first lateral region 14 in the direction of the upper side 13 of the vehicle body 3 and placing the sealing unit 18 against the upper side 13 of the vehicle body 3 in order to form a seal.

The further groove 38 of the vehicle 1 according to FIG. 5 is arranged, like the further groove 23 of the vehicle 1 according to FIG. 1, in a support arm region, or rather in the region of a free end of the support arm 24, which engages under the faceplate 4 starting from the first lateral region 14 in the direction of the second lateral region 15.

In the region of its lateral surface 31 which faces the roof rail 2, the faceplate 4 has a stop region 44, the free end 45 of which comes to rest on the support arm 24 at a defined swiveling angle of the faceplate 4 about the first lateral region 14 in the direction of the support arm 24 and defines a displacement of the second lateral region 15 of the faceplate 4 relative to the support arm 24 and to the upper side 13 of the vehicle body 3.

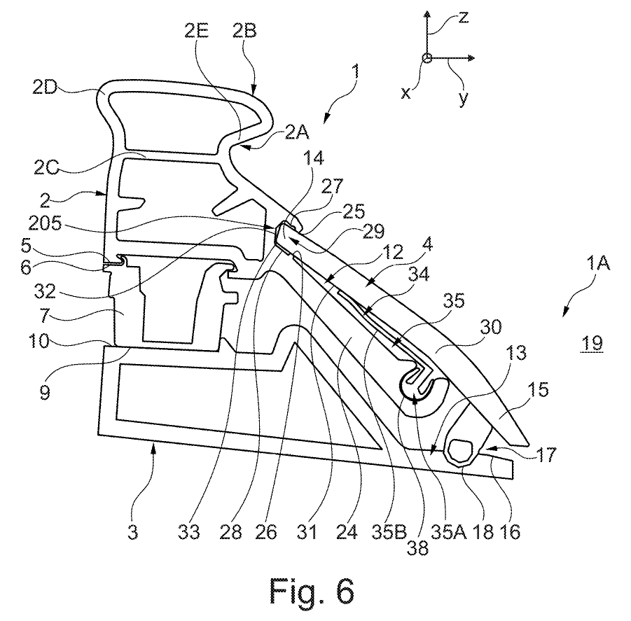

FIG. 6 shows a further embodiment of the vehicle 1 in a representation that substantially corresponds to FIG. 5 and in which the resilient coupling element 35 comprises a flat spring 35B in addition to the spring clip 35A. The flat spring 35B, which can preferably be produced from steel and implemented as a leaf spring, is connected at one end to the faceplate 4 and at the other end via the spring clip 35A to the roof rail 2 and applies a positioning force directed in the direction of the upper side 8 of the vehicle body 3 to the faceplate 4. The flat spring 35B, too, can either be formed as one piece and extend substantially over the entire length of the faceplate 4 or comprise flat spring portions that are spaced apart from each other.

The embodiment shown in FIG. 6 of the vehicle 1 is otherwise structured in the same way and functions in the same way, in the region of the roof rail 2, the vehicle body 3 and the faceplate 4 in operative connection with each of these, as the embodiment of the vehicle 1 according to FIG. 5; therefore, reference is made in this regard to the preceding description of FIGS. 1-5.

In both the embodiment of the vehicle 1 according to FIG. 5 and the embodiment of the vehicle 1 according to FIG. 6, an incorrect positioning of the roof rail 2 with respect to the predefined mounted position can be compensated for by means of the coupling element 35. By means of the coupling element 35, a distance between the underside 31 of the faceplate 4 and the support arm 24 caused by the incorrect positioning of the faceplate 4 can vary such that a width of the gap 17 has a defined value in each case due to the spring constants of the coupling element 35 and the sealing unit 18 regardless of an incorrect positioning of the roof rails 2, and widenings or narrowings of the gap widths that would impair the visual appearance of the seam of the gaps 17 are avoided.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Vehicle
1A Outer side of the vehicle roof
2 Roof rail
2A Constricted cross-sectional region
2B Wide cross-sectional region
2C Web region
2D, 2E Lateral wall of the hollow profile
3 Vehicle body
3A Roof channel
3B Roof channel sealing unit
4 Faceplate
5 Underside of the roof rail
6 Bearing surface of the adapter element
7 Adapter element
8 Screw joint
9 Underside of the adapter element
10 Bearing surface of the vehicle body
11 Further screw joint
12 Lateral outer wall region of the roof rail
13 Upper side of the vehicle body
14 First lateral region of the faceplate 4
15 Second lateral region of the faceplate 4
16 Region of the upper side of the vehicle body
17 Gap
18 Sealing unit
19 Surroundings of the vehicle
20 Groove
205 Groove
21 Connecting region
22 Connecting element
23 Further groove
24 Support arm
25, 26 End of the groove leg
27, 28 Groove leg
29 Opening cross section of the groove 205
30, 31 Lateral surface of the faceplate
32 Groove base of the groove 205
33 Groove cross section of the groove 205
34 Connecting region of the faceplate
35 Resilient coupling element
35A Spring clip
35B Flat spring
36 Web
37 Coupling region
38 Further groove
39 Groove base of the further groove 38
40 Opening cross section of the further groove 38
41 Tip of the coupling region
42, 43 Lateral spring arm portions
44 Stop region
45 Free end of the stop region
X Vehicle longitudinal direction
Y Vehicle transverse direction
Z Vehicle vertical direction

What is claimed is:

1. A vehicle, comprising:
a vehicle body;
roof rails connected to the vehicle body, each of the roof rails extending in a vehicle longitudinal direction in a region of a respective outer side of the vehicle roof;
faceplates; and
sealing units,
wherein a lateral outer wall region of each of the roof rails and an upper side, associated with one of the lateral outer wall regions, of the vehicle body, are covered by a respective one of the faceplates,
wherein a first lateral region of each of the faceplates is connected to one of the roof rails, and
wherein a second lateral region of each of the faceplates defines a gap with a region of the upper side of the vehicle body, the gap being sealed via a respective one of the sealing units.

2. The vehicle according to claim 1, wherein the first lateral regions of the faceplates each engage in a groove of the roof rails.

3. The vehicle according to claim 2, wherein
the grooves each have a substantially C-profiled cross section,
ends, running so as to be directed towards each other, of groove legs each define an opening cross section of the groove and rest flush against lateral surfaces of the faceplates.

4. The vehicle according to claim 3, wherein
the opening cross sections of the grooves are each smaller than a groove cross section adjoining the opening cross section in the direction of a groove base.

5. The vehicle according to claim 1, wherein,
in a connecting region which is associated with the roof rails and lies between the first and second lateral regions, the faceplates are each in operative connection with the roof rails via at least one resilient coupling element.

6. The vehicle according to claim 5, wherein
the resilient coupling elements each comprise at least one flat spring, which are each connected at one end to one of the faceplates and at the other end to one of the roof rails and apply a positioning force directed toward one of the upper sides of the vehicle body to each of the faceplates.

7. The vehicle according to claim 5, wherein
the resilient coupling elements each have at least one spring clip, which are firmly connected to the faceplates and are each held in a further groove of the roof rails so as to be displaceable against a spring pretensioning of the spring clips,
the spring pretensioning applies a positioning force directed toward upper sides of the vehicle body to each of the faceplates.

8. The vehicle according to claim 7, wherein
the further grooves are each formed in a region of a support arm of the roof rails, with which the roof rails engage under the faceplates starting from the first lateral region in the direction of the second lateral region.

9. The vehicle according to claim 1, wherein,
in an underside region, the roof rails each rest on a bearing surface of an adapter element and are firmly connected to the vehicle body.

10. The vehicle according to claim 1, wherein
the sealing units are each arranged between undersides of the second lateral regions of the faceplates and the upper sides of the vehicle body in order to seal the gaps between the faceplates and the vehicle body, and apply a positioning force directed away from the upper sides of the vehicle body to each of the faceplates.

11. The vehicle according to claim 8, wherein
the faceplates have, in the region of their lateral surfaces facing the roof rails, a stop region, the free ends of which come to rest on the support arms from a defined swiveling angle of the faceplates about the first lateral regions in the direction of the support arms.

12. The vehicle according to claim 2, wherein,
in a vehicle vertical direction above the grooves, the roof rails each have a cross-sectional region that is constricted in a vehicle transverse direction and a cross-sectional region that adjoins the former region in the vehicle vertical direction and is wider in the vehicle transverse direction.

13. The vehicle according to claim 12, wherein
the roof rails have, at least in the constricted cross-sectional region, a hollow profile which comprises a web region that runs in a vehicle transverse direction and extends between lateral walls that define the hollow profile.
